(19) United States
(12) Patent Application Publication
(10) Pub. No.: US 2005/0096944 A1
(43) Pub. Date: May 5, 2005

(54) Method, system and computer-readable medium useful for financial evaluation of risk

(76) Inventor: Shaun Patrick Ryan, Walnut Creek, CA (US)

Correspondence Address: PATRICK REILLY, BOX 7218, SANTA CRUZ, CA, 95061-7218, US

(21) Appl. No.: 10/697,066

(22) Filed: Oct. 30, 2003

(51) Int. Cl. G06F 17/60

(52) U.S. Cl. 705/4

(57) ABSTRACT

A method, computer system and computer-readable medium for evaluating a risk to the financial value of a property or an aspect of property is provided. The risk evaluations of a threat or threats and are integrated with estimates of the potential extent of damages in light of certain characteristics of the property. A quantitative risk value is then assigned to the property or aspect of the property. The quantitative risk value may be used to determine insurance premiums and other financial parameters related to the property, one or more aspects of the property, or a venture related to the property or one or more aspects of the property.

### FIELD OF THE INVENTION

The present invention relates to the financial evaluation of risk to properties and aspects of a financial asset from an act or omission imposing a legal liability or a destructive act, or an act that degrades a state of an asset, a corporation or a property. More particularly, the present invention relates to relating an evaluation of likelihood of damage to an asset, a corporation, a property or an aspect of a property, and an estimate of a degree of damage to a property or an aspect of a property for the purpose of risk assessments and/or financial risk valuations.

### BACKGROUND OF THE INVENTION

Certain fields of risk assessment, to include insurance premium valuation and financial services estimations, are fundamentally or significantly concerned with the reliability and integrity of the data used to estimate the likelihood of damage to a property, a corporation, or an asset, and the possible extent of damage property to the property, corporation or asset. In particular, insurance policy calculations are typically based upon the likelihood of an occurrence of a risk of an identified type or source, and of an estimate of the likely degree of damage that the occurrence might impose upon an identified property, asset, or corporation.

Ratings services are presently used by the insurance industry, wherein an experienced evaluator of a designated source of risk, e.g., fire, director's and officer's liability, estimates the susceptibility of an asset, such as a building or a corporation, to damage from the designated source of risk. The same expert or another evaluator may then forecast the potential magnitude of reduction in financial value or valuation of the asset that may be caused in the event of damage caused by the designated risk source.

The prior art insurance evaluation techniques rely upon long-term historical findings and records of outcomes to determine the validity and reliability of risk ratings services and the estimates, forecasts and opinions of the ratings sevices. The effect of the opinions of the ratings services on the susceptibility to and likelihood of damage to a property, asset or corporation on investors and financial partners can partially determine the market price of securities related to the property, asset or corporation, and/or the interest rate of a loan issued to a person or corporation. Yet the lack of standardized metrics relevant to many sources of risk, such as terrorist acts, acts or war, directors' and officers' liability, political instability, degradation of information technology systems, and supply chain interruptions or disruptions.

There is, therefore, a long felt need to a method and a system that efficiently provides a standardized metric for information related to a property or an aspect of a property, wherein the metric presents an improved degree of reliability in quantifying risk.

### OBJECTS OF THE INVENTION

It is an object of the present invention to provide a method that enables an association of likelihood of damage to a property or an aspect of a property with an estimate of the extent of damage possible to the property or the aspect of the property.

It is an additional optional object of the present invention to provide a method to inter-relate observations of a property, whereby the informational output of the method is of improved reliability for use in automated financial valuations of possible damage to the property or an aspect of the property.

It is a further object of certain preferred embodiments of the present invention to enable a user of an information technology database to evaluate an existing threat to a property or an aspect of the property.

It is another object of certain alternate preferred embodiments of the present invention to enable an assessor of property to assign and compare risk assessments to at least two properties, and wherein each risk assessment is assigned a quantitative value.

It is yet another object of certain still alternate preferred embodiments of the present invention to provide one or more categories of evaluation data regarding at least two properties, wherein the relative risk assessments of each property may be generated in light of one or more selected categories of data.

### SUMMARY OF TH INVENTION

These and other objects will be apparent in light of the prior art and this disclosure. According to the method of the present invention, methods, apparatus, and computer-readable media are disclosed for enabling the evaluation of a risk to a property, asset, or corporation, or an aspect of a property, asset or corporation. The term property is defined herein to comprise any real property, personalty, person, legally created person, corporation, entity, partnership, venture, association, collective, financial security, or other suitable real, artifical or virtual entity, object or person that may be financially evaluated, or may at least partially determine the financial valuation of an other property.

A first preferred embodiment of the method of the present invention comprises an algorithm useful for calculating a summed risk factor related to a property or an aspect of a property. The risk factor may be expressed as summed, wherein F(x) is derived upon the basis of the set of security values that include Pt, N, Ps, Pc, n1, Pr, and n2, wherein:
F(x)=(Pt)(N−Ps)(Pc/n1+Pr/n2); and
Pt=a dynamic weighted average of a plurality of threat parameters;
Ps=a dynamic weighted average of a plurality of security parameters;
N=a real number, preferably an integer, that equals the maximum possible value of Ps;
Pc=a score meant to represent and be proportional to a risk or threat posed to the property by a related political organization, e.g. a national government, of a geography which the property is related to or sited within;
n1=a real number for weighting of the value of the Pc;
Pr=a score meant to represent and be proportional to a risk or threat posed to the property by a subunit, e.g. a city or a district, of the related political organization of Pc; and
n2=a real number for weighting of the value of the Pr.

The values of n1 and n2 are each equal to the integer two in certain yet alternate preferred embodiments of the present invention. The security values of Pt, N, Ps, Pc, Pr, n1 and n2 may be provided or derived at least partially by the input or judgment of an individual expert or assessor, or by two, or by a plurality of experts or assessors. Each expert or assessor may contribute to the derivation of only one or more than one security value.

The method of the present invention optionally comprises providing the evaluator with a set of criteria for the evaluator to provide judgments regarding, whereby various properties may be evaluated by one or more evaluators and the judgments provided by the evaluator(s) may be more standardized. The set of criteria may include physical security aspects of a real property, such as (1) the existence or degree of illumination of at least part of the property, (2) the existence, responsiveness and quality of a security force, (3) door and portal lock and key controls, (4) CCTV observation systems, (5) communications infrastructure, (6) relevant critical assets, (7) the existence, quality and likelihood of execution of contingency plans, (8) controls over third party entry onto the property or its environs, (9) the security of proprietary information, (10) controls over a perimeter of at least part of the property, (11) psychological barriers to intruders, e.g., the perceived sacredness of a location or facility, e.g a locale of religious significance, (12) alarm systems, (13) vehicle controls, (14) hiring practices, (15) employment practices, (16) bomb threat planning, (17) explosion recovery planning, and (18) alternative communication capability and preparedness.

Where the property includes or is an element of real property, or another suitable type of property known in the art, the evaluation of the property may include a consideration of the location and the character of the geography proximate and/or distant from the real property and, the metes & bounds of the real property. Global positioning data (“GPS data”) as derived from a suitable prior art GPS system may be integrated into the evaluation method of the real property.

The evaluator may determine the likelihood of risk to the property from an identified risk source, e.g., by an act of sabotage, or an act caused by a paramilitary or a military team, organization or combatant, and the evaluator may additionally or alternatively determine the susceptibility of the property to damage that an assault against the property from an identified risk source may cause or impose. The terms expert, assessor, risk assessor, evaluator, and appraiser are defined herein to include a natural person, team of persons, system, or entity that is capable of observing, acquiring and/or collecting data describing or related to a property, and making estimates or evaluations regarding the property at least partially on the basis of the observed, acquired or collected data.

Certain alternate preferred embodiments of the method of the present invention comprise a method & algorithm that includes the collection of information describing, relating to, or concerning a property for the purpose of generating risk valuations relevant to the evaluation of risk to the property by one or more sources. Sources of risk may include terrorists acts, military or paramilitary acts, damage to an information technology system or the functioning of the information technology system, allegations of liability based upon an act, error or omission of a corporate directors or officers, degradation of a supply chain or performance of the supply chain, and political instability. The method of the present invention optionally comprises a risk assessment conducted by one or more in-house or independent experts wherein the experience and/or judgment of the expert is relevant to the risk assessment. These assessments may be collected and attached to an internet based software program that drives those independent assessments and detailed information through an algorithm which generate a standardized scoring of F(x). This score of F(x) may then be used by a financial, insurance and rating agency to better understand and categorize a defined risk type. Certain still alternate preferred embodiments of the present invention may additionally or alternately be used to identify a suggested financial limit of insurance coverage. Various alternate preferred embodiments of the method of the present invention may include score related to the likelihood and/or potential severity of damage causable by political risk, directors' and officers' liability, information technology system degradation, supply chain impairment, and other suitable sources and types of damage to property or aspects of property.

The term information technology system is defined herein to be or comprise a personal computer, personal digital assistant, workstation, networked computer, computer network or other suitable electronic computer, calculator, computational engine, or device known in the art. The term computer network is defined herein to be or comprise the Internet, an Extranet, an Intra-net, or other suitable computer network known in the art. The term cyber-threat is defined herein to comprise an act or omission that degrades a computer network or an information technology system, and wherein a cyber-threat may be or comprise a breach of data security of an information technology system or a computer network, a software worm, a software virus, a software bug, an error in software use, application or execution, or other suitable cause of damage to or degradation in the operation of a computer network or an information technology system.

Certain still alternate preferred embodiments of the method of the present invention may comprise an operational risk of a motorized vehicle, an aircraft, a watercraft, a boat, an ocean going vessel, an equipment, an electromechanical system, a chemical processing system, a petroleum or petro-chemical processing or refining plant, a medical device, an information technology system, a computer network, or other suitable devices, vehicles, plants or systems known in the art.

Another alternate preferred embodiment of the method of the present invention provides a computer system, the computer system configured to execute a risk assessment software program, the risk assessment software program at least partially provided to the computer system via a computer-readable medium. The computer system may include a processor for executing the risk assessment software program, a memory module communicatively linked with the processor, and the memory module for supporting the processor in executing the risk assessment program. The computer readable-medium may be communicatively linked to the processor, and the computer-readable medium may carry one or more sequences of one or more instructions for buffering data. The execution of the one or more sequences of the one or more instructions by one or more processors may cause the one or more processors to perform the steps of:
(a.) receiving an evaluation of the susceptibility to damage of the property by a terrorist action that may affect the at least one aspect of the property;
(b.) receiving an evaluation of the likelihood of a terrorist action directed against the property; and
(c.) determining the quantitative risk value of the property at least partially in relationship to (1) the evaluation of the susceptibility to damage by terrorist action of the at least one aspect of the property, and (2) the evaluation of the likelihood of a terrorist action directed against the property, whereby the quantitative risk value may be used by an insurer in setting an insurance premium for an insurance policy.

Yet another alternate preferred embodiment of the method of the present invention provides a method for determining a magnitude of an insurance premium of an insurance policy, or a risk assessment factor upon which an insurance premium is at least partially derived from or in relation to, where the insurance policy is meant to protect an insurance policy purchaser from a degradation of financial value of an aspect of an entity due to a potential occurrence of a specified character of event or condition, the method comprising:
(1) collecting a set of parameters related to at least one aspect of the entity;
(2) providing the set of parameters to a risk assessment expert;
(3) informing the risk assessment of the specified character of the potential event or condition to the expert;
(4) receiving a first assessment factor from the risk assessment expert of the likelihood of occurrence of the potential event or condition;
(5) receiving a second assessment factor from the risk assessment expert of an estimate of damage to the aspect of the entity likely to be caused by the occurrence of the potential event or condition; and
(6) calculating the magnitude of the insurance premium at least partially on the basis of the first assessment factor and the second assessment factor.

The magnitude of the insurance premium or the risk assessment factor may be at least partially calculated on the basis of the following formula:
(Pt*(S−Ps)*Pc),
where Pt is proportionally related to the magnitude of a perceived threat to the aspect of the entity, Ps is proportionally related to an evaluation of the physical security of the aspect of the entity, and Pc is proportionally related to an evaluation of a political risk that might affect the aspect of the entity. The formula may be calculated by an information technology system. The specified character of event or occurrence may be defined as or related to an event caused by a terrorist act, a financial liability held against an officer or a director of a corporation, a political risk, degradation or damage to an information technology system or performance of an information technology system, degradation or damage to a supply chain related to at least one aspect of the entity, or performance of the supply chain.

Other optional aspects of the present invention include a method, system and a computer-readable medium configured to carry out the foregoing steps. The term computer-readable media is defined herein to comprise memory internal to or linked with an information technology system, to include secondary storage devices, including hard disks, floppy disks, or CD-ROM; a carrier wave from the Internet or other network; or other forms of RAM or ROM.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic diagram of a property having a plurality of aspects;

FIG. 2 is a list of security factors of the property of FIG. 1;

FIG. 3 is a listing of threat factors related to the property of FIG. 1;

FIG. 4 illustrates a computer generated blast simulation scenario designed to predict damage to the property of FIG. 1;

FIG. 5 is a flowchart of a computer program capable of implementing a second preferred embodiment of the method of the present invention, wherein the second preferred embodiment of the method of the present invention comprises an invented algorithm, and optionally further comprising one or more steps or logical elements of the first preferred embodiment of the method of the present invention; and

FIG. 6 is a representation of an information technology system comprising a computer system, a computer-readable medium and an optional communications network by which the method of the present invention may be executed FIG. 2 may be executed.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

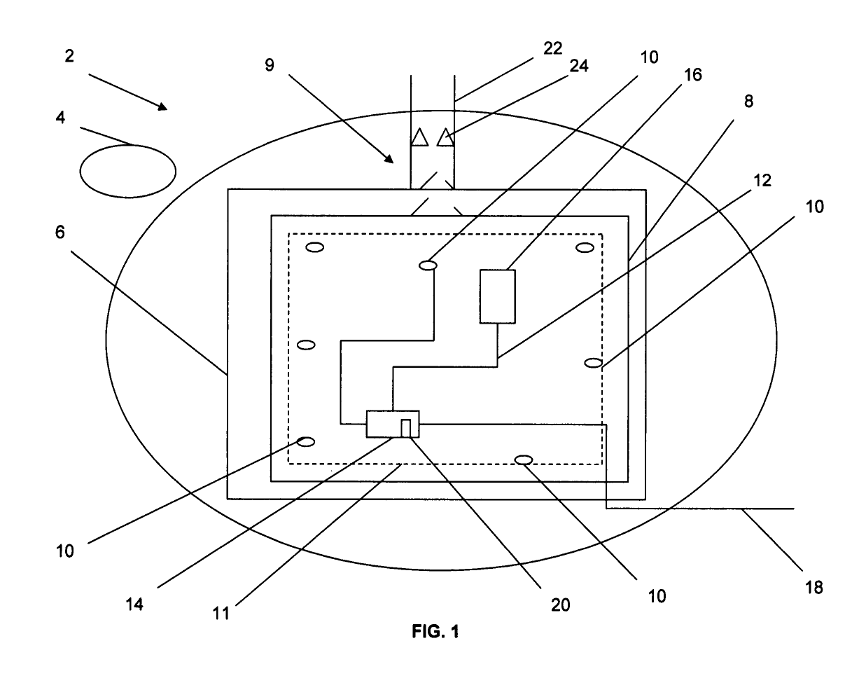

Referring now generally to the Figures and particularly to FIG. 1, FIG. 1 is a schematic diagram of a property 2 having a plurality of aspects. The plurality of aspects include an environ 4 proximate to the property 2, an outer fence 6, an inner fence 8, a set of gates 9, a plurality of illumination systems 10, an alarm system 11, a communications link 12 between a security center 14 and a facility 16, an external communications system 18, a secondary wireless communications equipment 20, and road 22. The road 22 includes obstacles 24 that force or encourage a driver of an approaching vehicle to travel at a low rate of speed, preferably less than 25 miles per hour. The set of gates 9 permit egress through the inner fence 6 and outer fence 8 and into the property 2.

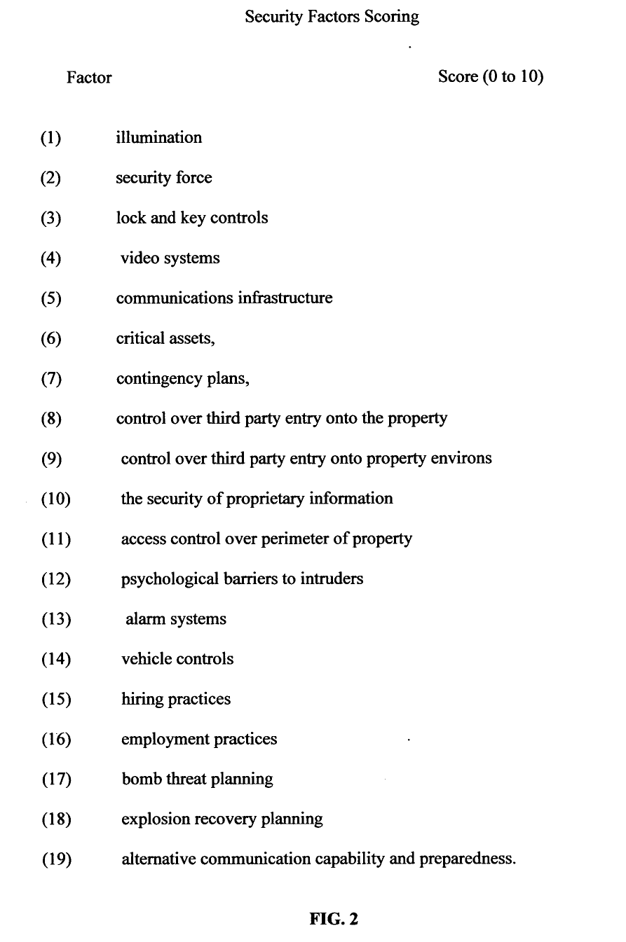

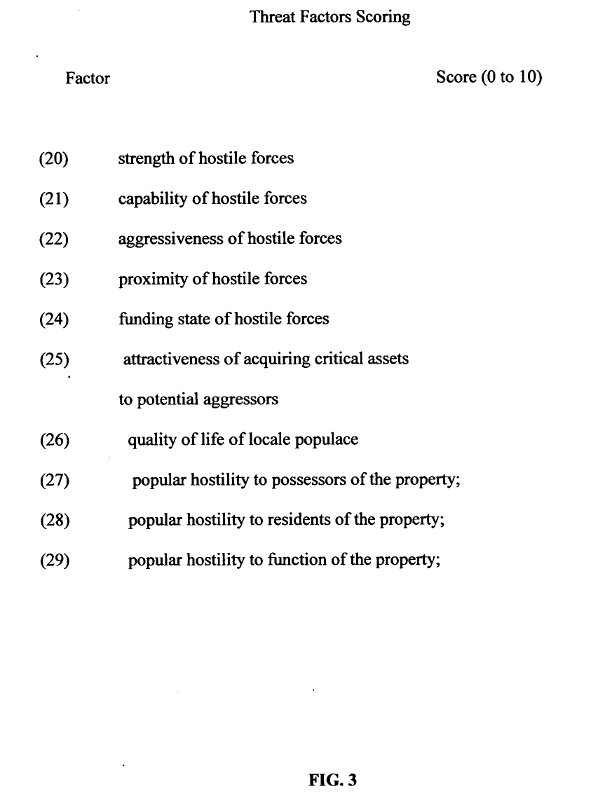

Referring now generally to the Figures and particularly to FIG. 2, FIG. 2 is a list of security factors of the property 2 of FIG. 1. The value of N of the equation defiinng F(x) as equal to or proportionally related to (Pt)(N−Ps)(Pc/n1+Pr/n2) is set at 10 in the scoring of the factors of FIG. 2. The dynamic averaging of the factors to produce a value equal to Ps enables the evaluator to deliver a summed score of the evaluated risk. The use of a set of risk factors allows the evaluator to document the issues which the evaluator considered in generating the Ps, and enables the generation of a more standardized risk evaluation by applying the same set, or substantially the same set of rsik factors, to the risk evaluation of a variety of properties. The use of the list of security factors of FIG. 3 thereby provides an improved standardization of risk evaluation and documentation for an audit trail of the evaluator's forecast of risk.

Referring now generally to the Figures and particularly to FIG. 3, FIG. 3 is a listing of threat factors related to the property 2 of FIG. 1. The evaluator may alternately, additionally or optionally also consider a set of threat factors to the property 2, wherein the higher the score of each threat factor indicates a higher threat to the property. The threat factor scores may be dynamically averaged on mathematically integrated into the calculation of F(x) by increasing the value of Ps, or by other suitable computational methods known in the art.

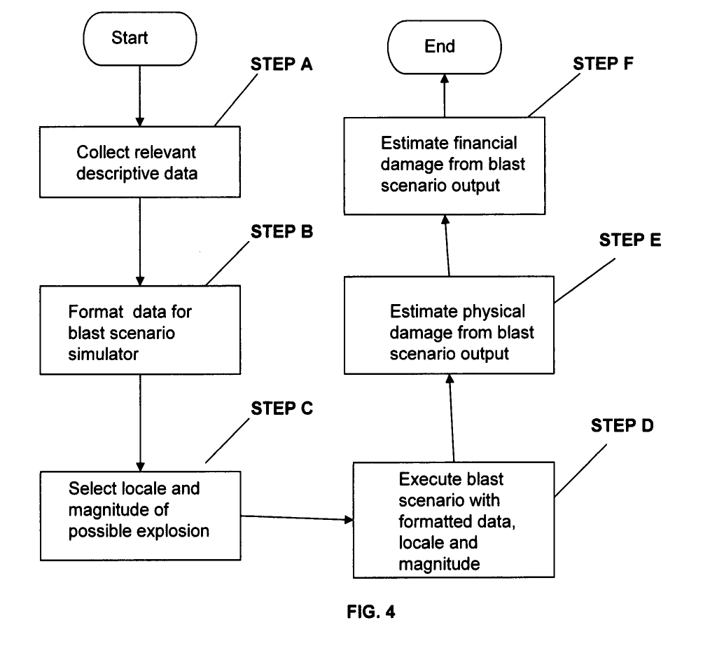

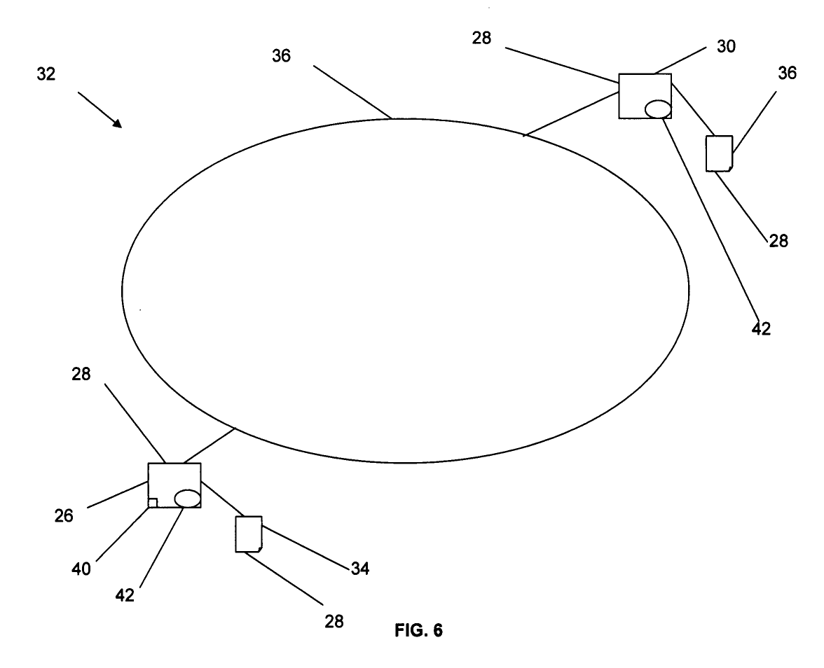

Referring now generally to the Figures and particularly to FIG. 4 and FIG. 6, FIG. 4 illustrates a computer generated blast simulation scenario designed to predict damage to the property of FIG. 1. A computer system 26 includes a software program 28 that effects a generation of a blast scenario. In Step A a set of relevant descriptive parameters are collected that are useful to the software program 28 in creating a mathematical model of the property 2, aspects of the property and optionally the environs of the property 2. In Step B the data is formatted for input into the software program 28. In Step C a locale for the origin of the blast and a putative magnitude of the blast are selected. In Step D the formatted descriptive data, locale and magnitude are input into the computer system 26 and the software program 28 is executed. In Step E an output of the software program 26 is provided to a user, a second computer system 30 (as per FIG. 7) and/or the software program 28 evaluates the degree of physical damage that the software program 26 forecasts would result to the property 2, and optionally to the environs of the property 2, if an explosion centered at the proposed locale and magnitude were to occur. In Step F the software program 26, the user, and/or the second computer system 30 may optionally estimate the financial damage likely to result to the property 2 and optionally to the environs of the property 2 as calculated at least partially on the basis of the estimated physical damage as forecasted by the software program 28 in Step E.

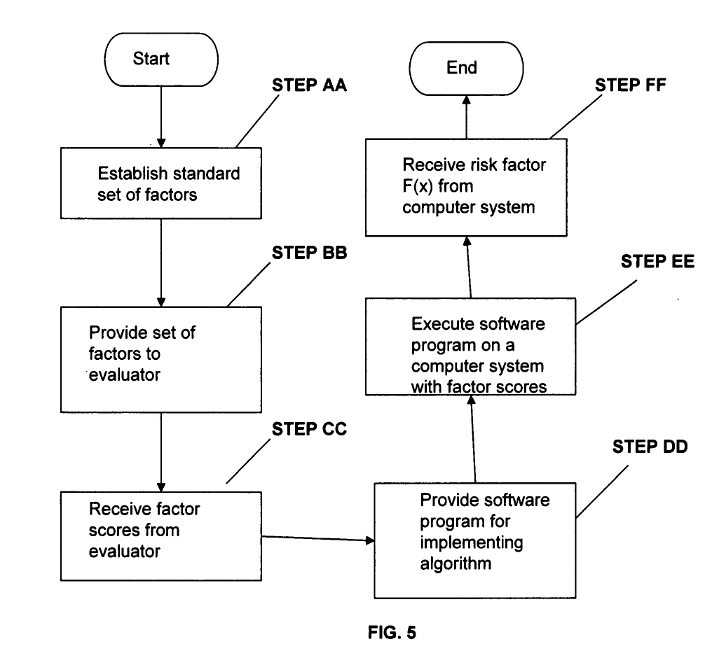

Referring now generally to the Figures and particularly to FIG. 5, FIG. 5 is a flowchart of a computer program capable of implementing a second preferred embodiment of the method of the present invention, wherein the second preferred embodiment of the method of the present invention comprises an invented algorithm, and optionally further comprising one or more steps or logical elements of the first preferred embodiment of the method of the present invention. In Step AA a standard set of risk factors for use in evaluating risk to the property 2 are established. In Step BB the standard set of factors are provided to an evaluator. In Step CC a set of scores of the set of factors are received from the evaluator. In Step DD the software program 28 for implementing the algorithm to generate the risk factor F(x) is provided by means of the computer system 26. In Step EE the software program 28 is executed on the computer system 26 with the factor scores as provided in Step CC. In Step FF the summed risk factor F(x) is received from the computer system. In certain alternate preferred embodiments of the method of the present invention the summed risk factor F(x) may be calculated at least partially by a person. In certain still alternate preferred embodiments of the method of the present invention risk factors and scores, and other suitable factors, values and scores known in the art may be applied to the algorithm in calculation of the summed risk factor. The algorithm used to generate the summed risk factor F(x) in the software program 28 may be selected from the group of algorithms consisting of:

A. F(x)=(Pt)(N−Ps)(Pc/n1+Pr/n2), wherein
Pt=a dynamic weighted average of a plurality of threat parameters;
Ps=a dynamic weighted average of a plurality of security parameters;
N=a real number, preferably an integer, that equals the maximum possible value of Ps;
Pc=a score meant to represent and be proportional to a risk or threat posed to the property by a related political organization, e.g. a national government, of a geography which the property is related to or sited within;
n1=a real number for weighting of the value of the Pc;
Pr=a score meant to represent and be proportional to a risk or threat posed to the property by a subunit, e.g. a city or a district, of the related political organization of Pc; and
n2=a real number for weighting of the value of the Pr.

B. F(x)=(Pt*(S−Ps)*Pc), wherein
Pt is proportionally related to the magnitude of a perceived threat to the aspect of the entity;
Ps is proportionally related to an evaluation of the physical security of the aspect of the entity; and
Pc is proportionally related to an evaluation of a political risk that might affect the aspect of the entity.

C. Another suitable algorithm known in the art.

Referring now generally to the Figures and particularly to FIG. 6, FIG. 6 is a representation of an information technology system 32 comprising the computer system 26, the second computer system 30, a computer-readable medium 34, a second computer-readable medium 36 and an optional communications network 36 by which the method of the present invention may be executed. The computer 26 may be a personal computer, a computer workstation, a personal digital assistant or other suitable electronic computation device known in the art. The communications network 36 may be or comprise the Internet, a computer network, an Intranet, an Extranet, a suitable telephonic network, or other suitable communications network known in the art. The software program 28 may be at least partially stored or partially distributed (1) in an optional memory 40 of the computer system 26 and/or (2) on the computer-readable medium 34 and made available to the computer system 26 via a computer-readable medium player 42, such as a hard disk drive or another suitable data input or input/output device known in the art. Alternatively or additionally the software program 28 may be at least partially supplied to the computer system 26 from the second computer system 30 via the communications network 38, and optionally from the second computer-readable medium 36.

The term “computer-readable medium” as used herein refers to any suitable medium known in the art that participates in providing instructions to the network 2 for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A method of assigning a quantitative risk value to a property, the quantitative risk value proportionally related to the likelihood of terrorist action against the property, comprising:
receiving an evaluation of the susceptibility to damage of the property by a terrorist action that may affect the at least one aspect of the property;
receiving an evaluation of the likelihood of a terrorist action directed against the property; and
determining the quantitative risk value of the property at least partially in relationship to (1) the evaluation of the susceptibility to damage by terrorist action of the at least one aspect of the property, and (2) the evaluation of the likelihood of a terrorist action directed against the property, whereby the quantitative risk value may be used by an insurer in setting an insurance premium for an insurance policy.

2. The method of claim 1, wherein the method further comprises:
receiving an estimate of the financial worth of at least one aspect of the property; and
determining the quantitative risk value at least partially in relationship to the estimate of the financial worth of the at least one aspect property.

3. The method of claim 1, wherein the method further comprises:
receiving an estimate of the financial worth of at least one aspect of the property; and
setting the insurance premium at least partially in relationship to the estimate of the financial worth of the at least one aspect of the property.

4. The method of claim 1, wherein the method further comprises:
receiving a geographic description of the area of the property; and
determining the quantitative risk value at least partially in relationship to the geographic description of the area of the property.

5. The method of claim 1, wherein the method further comprises:
modeling an assault scenario simulation, the assault scenario simulation structured in consideration of the susceptibility to damage of the at least one aspect of the property by a mode of assault; and
generating a damage prediction value by running the assault simulation under a condition of an occurrence of the mode of assault directed against the property, the damage prediction value at least partially related to the degree of damage likely to be inflicted upon the at least one aspect of the property by an actual occurrence of the mode of assault directed against the property.

6. The method of claim 5, wherein the method further comprises determining the quantitative risk value F(x) at least partially in relationship to the following formula:
F(x)=(Pt)×(N−Ps)×(Pc/n1+Pr/n2); wherein
Pt=a dynamic weighted average of a plurality of threat parameters;
Ps=a dynamic weighted average of a plurality of security parameters;
N=a real number, preferably an integer, that equals the maximum possible value of Ps;
Pc=a score meant to represent and be proportional to a risk or threat posed to the property by a related political organization, e.g. a national government, of a geography which the property is related to or sited within;
n1=a real number for weighting the value of the Pc;
Pr=a score meant to represent and be proportional to a risk or threat posed to the property by a subunit, e.g. a city or a district, of the related political organization of Pc; and
n2=a real number for weighting the value of the Pr.

7. The method of claim 1, wherein the method further comprises:
modeling a blast scenario simulation, the blast scenario simulation structured in consideration of the susceptibility to damage of the at least one aspect of the property by an explosive force of a selected magnitude; and
generating a damage prediction value by running the blast scenario simulation under a condition of an occurrence of the explosive force of the selected magnitude proximate to the at least one aspect of the property, the damage prediction value at least partially related to the degree of damage likely to be inflicted upon the at least one aspect of the property by an actual occurrence of the explosive force of the selected magnitude proximate to the at least one aspect of the property.

8. The method of claim 7, wherein the method further comprises determining the quantitative risk value at least partially in relationship to the damage prediction value.

9. The method of claim 1, wherein the method further comprises determining the likelihood of a terrorist action directed against the property at least partially in relationship to a site factor selected from the group of site factors consisting of country threat level, regional threat level, city threat level, history of attempted terrorist acts related to the property, history of accomplished terrorist acts related to the property, trophy status of an aspect of the property, degree of threat against the property, capability of terrorist actor, and targeting of the property by a terrorist actor.

10. The method of claim 1, wherein the method further comprises determining the evaluation of the susceptibility to damage of the property by a terrorist action at least partially in relationship to a security factor selected from the group of security factors consisting of illumination of the property, security force evaluation, lock and key controls, video monitoring equipment, communications infrastructure, critical assets, contingency plans, third party access controls, proprietary information, perimeter controls, psychological barriers, access controls, alarms, vehicle controls, employment practices, bomb threat plans, and communications plans.

11. The method claim 1, the method further comprising providing the quantitative risk value to a financial services firm.

12. The method claim 2, the method further comprising providing the quantitative risk value to a financial services firm.

13. The method of claim 1, wherein the at least one aspect of the property comprises an information technology element, and the method further comprises determining the evaluation of the susceptibility to damage of the property by a terrorist action at least partially in view of a susceptibility to damage of the information technology element.

14. The method of claim 13, wherein the method further comprises determining the susceptibility to damage of the information technology element by software means.

15. The method of claim 13, wherein the method further comprises determining the susceptibility to damage of the information technology element by a software means delivered to the information technology system by computer-readable media.

16. The method of claim 13, wherein the method further comprises determining the susceptibility to damage of the information technology element by a software means delivered to the information technology system via the Internet.

17. The method of claim 16, wherein the software means is selected from the group of software types consisting of a software program error, a software agent, a software virus, a software worm, and a software program.

18. A computer-readable medium carrying one or more sequences of one or more instructions for buffering data, wherein the execution of the one or more sequences of the one or more instructions by one or more processors, causes the one or more processors to perform the steps of:
receiving an evaluation of the susceptibility to damage of the property by a terrorist action that may affect the at least one aspect of the property;
receiving an evaluation of the likelihood of a terrorist action directed against the property; and
determining the quantitative risk value of the property at least partially in relationship to (1) the evaluation of the susceptibility to damage by terrorist action of the at least one aspect of the property, and (2) the evaluation of the likelihood of a terrorist action directed against the property, whereby the quantitative risk value may be used by an insurer in setting an insurance premium for an insurance policy.

19. The computer-readable medium of claim 19, wherein one or more instructions is provided to one or more processors via the Internet.

20. A computer system, the computer system configured to execute a risk assessment software program, the risk assessment software program at least partially provided to the computer system via a computer-readable medium, the computer system comprising:
a processor for executing the risk assessment software program;
a memory module communicatively linked with the processor, and the memory module for supporting the processor in executing the risk assessment program; and
the computer-readable medium, the computer readable-medium communicatively linked to the processor, and the computer-readable medium carrying one or more sequences of one or more instructions for buffering data, wherein the execution of the one or more sequences of the one or more instructions by one or more processors, causes the one or more processors to perform the steps of:
receiving an evaluation of the susceptibility to damage of the property by a terrorist action that may affect the at least one aspect of the property;
receiving an evaluation of the likelihood of a terrorist action directed against the property; and
determining the quantitative risk value of the property at least partially in relationship to (1) the evaluation of the susceptibility to damage by terrorist action of the at least one aspect of the property, and (2) the evaluation of the likelihood of a terrorist action directed against the property, whereby the quantitative risk value may be used by an insurer in setting an insurance premium for an insurance policy.

21. A method for determining a magnitude of an insurance premium of an insurance policy, the insurance policy meant to protect an insurance policy purchaser from a degradation of financial value of an aspect of an entity due to a potential occurrence of a specified character of event or condition, the method comprising:
collecting a set of parameters related to at least one aspect of the entity;
providing the set of parameters to a risk assessment expert;
informing the risk assessment of the specified character of the potential event or condition to the expert;
receiving a first assessment factor from the risk assessment expert of the likelihood of occurrence of the potential event or condition;
receiving a second assessment factor from a second risk assessment expert of an estimate of damage to the aspect of the entity likely to be caused by the occurrence of the potential event or condition; and
calculating the magnitude of the insurance premium at least partially on the basis of the first assessment factor and the second assessment factor.

22. The method of claim 21, wherein the magnitude of the insurance premium is at least partially calculated on the basis of the following formula: (Pt*(S−Ps)*Pc), where Pt is proportionally related to the magnitude of a perceived threat to the aspect of the entity, Ps is proportionally related to an evaluation of the physical security of the aspect of the entity, and Pc is proportionally related to an evaluation of a political risk that might affect the aspect of the entity.

23. The method of claim 22, wherein the formula is calculated by an information technology system.

24. The method of claim 22, wherein the second risk assessment expert is identical with the first risk assessment expert.

25. The method of claim 21, wherein the specified character of event or occurrence is defined as caused by a terrorist.

26. The method of claim 21, wherein the specified character of event or occurrence is defined as a financial liability held against an officer or a director of a corporation.

27. The method of claim 21, wherein the specified character of event or occurrence is defined as caused by a political risk.

28. The method of claim 21, wherein the specified character of event or occurrence is defined as damage to an information technology system.

29. The method of claim 21, wherein the specified character of event or occurrence is defined as damage to a supply chain related to at least one aspect of the entity.
